(19) United States
(12) Patent Application Publication
(10) Pub. No.: US 2003/0047171 A1
(43) Pub. Date: Mar. 13, 2003

(54) Integrated egr valve and cooler

(76) Inventors: Richard J. Vaughan, Ormond Beach, FL (US); Dimitri L Vamvakitis, Pontiac, MI (US); Jerry Holden, Smithville, TN (US); Jack Morais, Clarkston, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/149,922

(22) PCT Filed: Dec. 14, 2000
(86) PCT No.: PCT/US00/33958

(30) Foreign Application Priority Data
Dec. 14, 1999 (US) 60170649

(51) Int. Cl. F02M 25/07

(52) U.S. Cl. 123/568.12

(57) ABSTRACT

An exhaust gas recirculation (EGR) cooling system includes a valve (14) and a cooler (12). A motor (28) opens the valve allowing hot fluid exhaust gas to flow into the valve. Cooling fluid continuously flows in and circulated around the valve (14), reducing the amount of heat transfer from the hot fluid to the valve components. The hot fluid travels through a plurality of tubes (20) in the cooler, continuing to transfer heat to the cooling fluid. As the hot fluid is cooled, the unburned gas in the hot fluid is recycled to be burned by the engine.

### BACKGROUND OF THE INVENTION The subject invention relates to exhaust gas recirculation (EGR) within a combustion engine.

EGR systems are increasingly being utilized to improve the efficiency of engines and reduce the harmful effects of exhaust gas on the environment. As an engine burns fuel, it produces an exhaust gas which contains unburned fuel and other impurities. The exhaust gas is redirected through the engine to burn any unburned fuel. Reburning the exhaust gas before it is released reduces the harmful effects of the exhaust gas on the atmosphere and enables the vehicle to meet government emission standards.

In order to recirculate the exhaust gas, EGR systems typically include a valve and a cooler. The valve regulates the amount of exhaust gas that is introduced back into the engine. The cooler cools the exhaust gas to a specified temperature which condenses the unburned fuel.

Prior EGR system include a separate valve and cooler. A drawback to utilizing a valve and cooler as separate components is that additional tubing is necessary, reducing the amount of space in the engine compartment. Additionally, the additional tubing allows the hot fluid to lose and/or gain heat as it is transported so that there is less control of the exhaust emission.

### SUMMARY OF THE INVENTION

An exhaust gas recirculation (EGR) cooling system includes a valve and a cooler. Exhaust gas from the engine is cooled and unburned gas is recycled back to the engine. Hot fluid exhaust gas from the engine enters the system on a hot side and is returned to the engine on a cold side. The cooler is divided into a shell section for a cooling fluid and a plurality of tubes for the hot fluid. The cooling fluid enters the cooler from the valve and exits the shell through an outlet nozzle. In the preferred embodiment, the tubes are such as are available under the trademark flexfin™.

The valve is attached to the hot side of the cooler and is connected to a motor which controls the opening and the closing of the valve. The valve includes a cooling fluid inlet and a hot fluid inlet and has a first chamber and a second chamber.

The cooling fluid continuously flows in through the cooling fluid inlet and into the first chamber. The motor opens the valve to allow the hot fluid to flow into the valve. The subject invention allows the cooling fluid to circulate around the valve in the first chamber, reducing the amount of heat transfer from the hot fluid to the valve components, prolonging the life of the valve. The cooling fluid flows into the second chamber and continues to remove heat from the hot fluid before entering the cooler. The hot fluid continues to transfer heat to the cooling fluid in the shell as the hot fluid flows through the tubes and exits the tubes at the cold side A. As the hot fluid is cooled, the unburned gas in the hot fluid is recycled to be burned by the engine.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a schematic of the exhaust gas recirculation system; and

FIG. 2 is a side view of the EGR valve.

### DETAILED DESCRIPTION OF THE PREFERRED EMBODIMENT

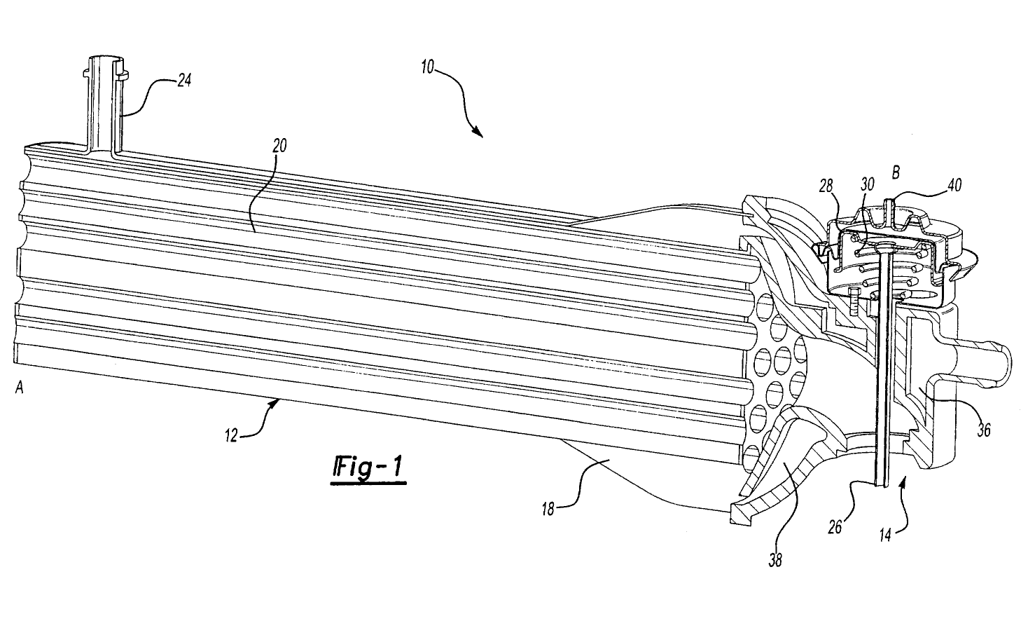

Referring to the Figures, wherein like numerals indicate like or corresponding parts throughout the several views, an exhaust gas recirculation (EGR) cooling system 10 is shown in FIG. 1. The system 10 cools the exhaust gas from an engine and recycles the unburned gas back to the engine. The system 10 has a hot side B where a hot fluid, i.e. the exhaust gas from the engine, enters the system and a cold side A where the hot fluid has condensed and is returned to the engine. The EGR system 10 comprises a cooler 12 and a valve 14. To those skilled in the art, the cooler 12 acts as a shell and tube heat exchanger. The cooler 12 is divided into a shell section 18 for a cooling fluid and a plurality of tubes 20 for the hot fluid. The cooling fluid enters the cooler 12 from the valve 14 and exits the shell 18 through an outlet nozzle 24. In the preferred embodiment, the tubes 20 are such as are available under the trademark flexfin™, which have a plurality of spirals for tube walls to increase heat transfer between the hot fluid and the cooling fluid.

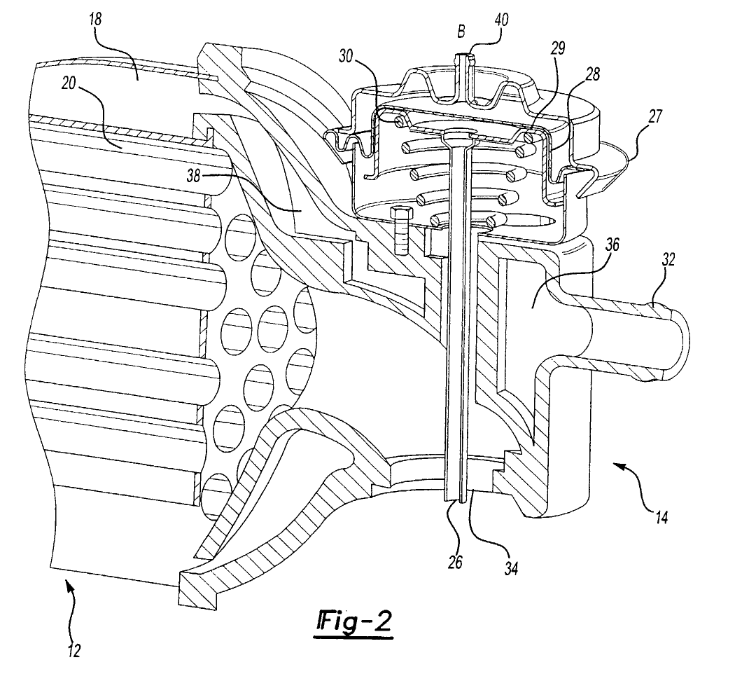

The valve 14 is attached to the hot side B of the cooler 12 and has a nozzle 40 which is connected to an electric or pneumatic motor. The motor controls the opening and closing of the valve 14. As seen in FIG. 2, the valve components includes a stem 26, an upper housing 27, a diaphragm 28, a diaphragm plate 29, and a spring 30. The valve 14 has a cooling fluid inlet 32 and a hot fluid inlet 34. The valve 14 also has a first chamber 36 and a second chamber 38.

The valve 14 is connected by any known means to the cooler 12. The cooling fluid continuously flows in through the cooling fluid inlet 32 of the valve 14 and into the first chamber 36. When the motor opens the valve 14, the hot fluid flows into the valve 14. In the prior art, the hot fluid heats up the valve components which shortens the life of the valve 14. The subject invention allows the cooling fluid to circulate around the valve stem 26, the diaphragm 28, the diaphragm plate 29, and the spring 30 in the first chamber 36. The cooling fluid reduces the amount of heat transfer from the hot fluid to the valve components which in turn prolongs the life of the valve 14. Next, the cooling fluid flows into the second chamber 38 of the valve 14 and continues to remove heat from the hot fluid before it enters the cooler 12. As the hot fluid flows through the tubes 20, the hot fluid continues to transfer heat to the cooling fluid in the shell 18. The hot fluid exits the tubes 20 at the cold side A. As the hot fluid is cooled, the unburned gas in the hot fluid is recycled to be burned by the engine.

There are many additional advantages to connecting and positioning the valve 14 before the cooler 12. First, the valve 14 remains free of contaminants from the cooling of the hot fluid which happens when the valve 14 is placed after the cooler 12. The second benefit is the hot fluid achieves a more consistent amount of cooling which makes the engine more efficient. If the valve 14 were spaced separately from the cooler, the additional tubing would allow the hot fluid to lose and gain heat as it was transported. Third, by attaching the valve 14 to the cooler 12, the engine achieves better control of the exhaust emissions because the hot fluid temperature out of the cooler is better controlled.

The invention has been described in an illustrative manner, and it is to be understood that the terminology which has been used is intended to be in the nature of words of description rather than of limitation. It is now apparent to those skilled in the art that many modifications and variations of the present invention are possible in light of the above teachings. It is, therefore, to be understood that the invention may be practiced otherwise than as specifically described.

1. An exhaust gas circulation system (10) comprising:
a valve (14) to control a flow of an exhaust entering said system;
at least one tube (20) in fluid communication with said valve (14) to carry said exhaust from said valve (14) and out of said system (10);
a valve chamber (36) surrounding a portion of said valve (14) to reduce heat transfer to said valve (14) and including a cooling fluid inlet (32) to allow entry of a cooling fluid into said system (10); and
a shell portion (18) defining a cooler chamber in fluid communication with said valve chamber (36) surrounding said at least one tube (20) to remove heat from said exhaust and including a cooling fluid outlet (24) to convey said cooling fluid from said system (10).

2. The system (10) as recited in claim 1 wherein said valve chamber (36) includes a first chamber (36) and a second chamber (38) for heat removal from said exhaust prior to entry into said shell portion (18).

3. The system (10) as recited in claim 1 wherein an actuator controls a degree of opening of said valve (14) to allow said exhaust to enter said valve (14) and said system (10).

4. The system (10) as recited in claim 1 wherein said valve (14) includes a stem (26) attached to and actuated by a diaphragm (28) at an end, a spring (30) attached to said diaphragm (28) and surrounding a portion of said stem (26), and a poppet attached to an opposing end of said valve (14).

5. The system (10) as recited in claim 1 wherein said cooling fluid passes through said valve chamber (36) to reduce heat transfer to said valve (14) and further passes through said shell portion (18) to remove heat from said exhaust passing through said at least one tube (20).

6. The system (10) as recited in claim 1 wherein said exhaust enters said valve (14) through a hot fluid inlet (34).

7. An exhaust gas recirculation system (10) comprising:
an actuator to control a degree of opening of a valve (14) to allow an exhaust to enter said valve (14) and said system (10);
a valve (14) to control a flow of an exhaust entering said system (10) through a hot fluid inlet (34);
at least one tube (20) in fluid communication with said valve (14) to carry said exhaust from said valve (14) and out of said system (20); and
a valve chamber (36) surrounding a portion of said valve (14) to reduce heat transfer to said valve (14) and including a cooling fluid inlet (32) to allow entry of a cooling fluid into said system (10); and
a shell portion (18) defining a cooler chamber in fluid communication with said valve chamber (36) surrounding said at least one tube (20) to remove heat from said exhaust and including a cooling fluid outlet (24) to convey said cooling fluid from said system (10).

8. The system (10) as recited in claim 7 wherein said valve chamber (36) includes a first chamber (36) and a second chamber (38) for heat removal from said exhaust prior to entry into said shell portion (18).

9. The system (10) as recited in claim 7 wherein said valve (14) includes a stem (26) attached to and actuated by a diaphragm (28) at an end, a spring (30) attached to said diaphragm (28) and surrounding a portion of said stem (26), and a poppet attached to an opposing end of said valve (14).

10. An exhaust gas recirculation system (10) comprising:
an actuator to control a degree of opening of a valve (14) to allow an exhaust to enter said valve (14) and said system (10);
a valve (14) including a stem (26) attached to and actuated by a diaphragm (28) at an end, a spring (30) attached to said diaphragm (28) and surrounding a portion of said stem (14), and a poppet attached to all opposing end of said valve (14) to control a flow of an exhaust entering said system through a hot fluid inlet (34);
at least one tube (20) in fluid communication with said valve (14) to carry said exhaust from said valve (14) and out of said system (10); and
a valve chamber (36) surrounding a portion of said valve (14) to reduce heat transfer to said valve (14) and including a cooling fluid inlet (32) to allow entry of a cooling fluid into said system (10), a first (36) and a second chamber (38); and
a shell portion (18) defining a cooler chamber in fluid communication with said valve chamber (36) surrounding said at least one tube (20) to remove heat from said exhaust and including a cooling fluid outlet (24) to convey said cooling fluid from said system (10).

11. A method fur cooling an exhaust comprising the steps of:
opening a valve (14) to control a flow of said exhaust into an exhaust gas recirculation system (10);
removing heat from said valve (4) by passing said cooling fluid from a cooling fluid inlet (32) into a valve chamber (36) surrounding said valve (14); and
removing heat from said exhaust by further passing said cooling fluid through a shell (18) of a cooler in fluid communication with said valve chamber (36), said shell (18) enclosing a plurality of tubes (20) containing said exhaust.
